(19) United States
(12) Patent Application Publication
(10) Pub. No.: US 2020/0309568 A1
(43) Pub. Date: Oct. 1, 2020

(54) Sensor Assembly for Detecting a Displacement in a Contactless Manner, and Method for Determining a Relative Position

(71) Applicant: Robert Bosch GmbH, Stuttgart (DE)

(72) Inventors: Ingo Herrmann, Friolzheim (DE); Fabian Utermoehlen, Leonberg (DE)

(21) Appl. No.: 16/099,723

(22) PCT Filed: May 4, 2017
(86) PCT No.: PCT/EP2017/060600

§ 371 Date: Nov. 8, 2018

(30) Foreign Application Priority Data
May 9, 2016 (DE) 10 2016 207 880.1

(51) Int. Cl. G01D 5/20; G01D 5/244

(52) U.S. Cl. CPC G01D 5/202; G01D 5/24485

(57) ABSTRACT

A sensor assembly for detecting a displacement in a contactless manner includes a target and a current sensor. The target includes a transmitter that moves along a measurement path and includes at least one measurement track and at least one correction track arranged together with the measurement track within a common geometry. The current sensor includes a measurement value sensor having at least two detection coils. At least one coil acts as a measurement coil, the signal of which is evaluated by a control unit to detect a displacement. At least one coil acts as a correction coil, the signal of which is evaluated by the control unit to correct the displacement detection. The control unit assigns a coil the measurement coil action if the corresponding coil is positioned over a first region or the correction coil action if the corresponding coil is positioned over a second region.

The invention is based on a sensor assembly for detecting a displacement in a contactless manner, according to the generic type of independent patent claim 1. The subject matter of the present invention also relates to a method for determining a relative position of a sensor in relation to a target of such a sensor assembly for contactless displacement measurement.

Sensor arrangements for contactless displacement measurement based on the eddy current principle are known from the prior art. The sensor assembly comprises a target with a measurement value encoder running along a measurement path which has at least one electrically conductive measuring track, and an eddy current sensor with a measurement value sensor which has at least one measuring coil which is arranged over the at least one electrically conductive measuring track. The electrically conductive measuring track changes in width along the measurement path in such a way that a degree of coverage of the at least one measuring coil by the electrically conductive measuring track changes along the measurement path. The measuring coil induces an eddy current in the electrically conductive measuring track, which current leads to a change in the measuring coil inductance, which is connected into an electrical oscillating circuit whose resonance frequency changes as a result. This frequency change can be evaluated as a measurement signal for displacement or angle measurement.

A tolerance-robust design requires the use of a plurality of sensor coils and a plurality of conductive tracks, which usually have an identical geometry, but are offset relative to each other in the measuring direction. In addition to the movement in the measuring direction (y direction), due to tolerances a displacement and distance changes may occur between the measuring coil and the electrically conductive measuring track, i.e. to a movement in the x-direction and the z-direction. Furthermore, a tilting of the target about the y-axis is possible. The tilting and the change of distance are particularly critical for the measurement method since the eddy current effect has a strong distance dependence.

An eddy current sensor for continuous displacement or angle measurement is known from DE 10 2004 033 083 A1, for example. The eddy current sensor comprises a sensor and a conductive encoder, wherein the sensor comprises at least one coil for generating eddy currents in the conductive encoder. Sensor and encoder can move in a motion direction relative to each other. A time-continuous path or angle measurement can be implemented by the fact that the encoder has a conductive track, which is designed in such a way that the complex impedance of the coil varies continuously when the track is scanned in the direction of motion.

### DISCLOSURE OF THE INVENTION

The sensor assembly for contactless displacement measurement having the features of independent patent claim 1 and the method for determining a relative position of a sensor in relation to a target of such a sensor assembly having the features of independent claim 16 have the advantage that at least one correction track and at least one correction coil are used for correcting the tilt and the distance. In this case, the target or the measurement value encoder is segmented and the eddy current sensor is implemented with at least two detection coils, which either perform the role of the measuring coils or the role of the correction coil, depending on the target position.

Embodiments of the present invention advantageously enable a compact sensor assembly for displacement measurement in a contactless manner, which provides at least as good tolerance robustness as sensor configurations known from the prior art, but has only one sensor printed circuit board and a target structured on only one side. The common segmented geometry used for the design of the at least one measuring track and the at least one correction track means that significantly reduced installation space is required, since the width can be reduced to one-third of the size. Another advantage that is obtained from the more tolerance-robust sensor assembly is a more cost-effective construction and connection technology, since higher installation tolerances may be accepted. The simple measurement principle also results in a high EMC robustness.

Embodiments of the present invention provide a sensor assembly for contactless displacement measurement, having a target which has a measurement value encoder running along a measurement path with at least one electrically conductive measuring track, and having an eddy current sensor with a measurement value sensor which comprises at least two detection coils. The measurement value sensor is arranged at a distance from the measurement value encoder and is movable in a relative manner along the at least one electrically conductive measurement track and said measurement value sensor at least partly covers this measurement track. At least one of the detection coils acts as a measuring coil, the measuring signal of which is evaluated by an evaluation and control unit to determine the displacement. The measurement value encoder has at least one electrically conductive correction track, which is arranged with at least one measurement track within a common geometry, wherein first regions with at least one measurement track and second regions with at least one correction track alternate periodically along the measurement path. At least one of the detection coils acts as a correction coil, the measuring signal of which is evaluated by the evaluation and control unit for correction of the displacement measurement, wherein the action of the individual detection coil as a measuring coil or as a correction coil varies along the measurement path. The evaluation and control unit assigns a detection coil the measuring coil action if the corresponding detection coil is positioned over a first region, or the correction coil action if the corresponding detection coil is positioned over a second region.

In addition, a method is proposed for determining a relative position of a sensor in relation to a target of such a sensor assembly for contactless displacement measurement. In the method, a detection coil is assigned the measuring coil action if the corresponding detection coil is positioned over a first region, or the correction coil action if the corresponding detection coil is positioned over a second region. At least one measuring signal of the detection coil acting as a correction coil is measured and evaluated to determine a spatial position of the measurement value sensor to the measurement value encoder. In addition, at least one measuring signal of the detection coil acting as a measuring coil is measured and corrected based on the specific spatial location of the measurement value sensor relative to the measurement value encoder, wherein the relative position of the eddy current sensor in relation to the target is determined from the corrected measuring signal of the detection coil acting as a measuring coil.

The target can be, for example, a printed circuit board on which the at least one electrically conductive measuring track and the at least one electrically conductive correction track are formed as one or more conductor tracks. This printed circuit board can also be implemented as a flexible circuit board film. The target can be arranged on a component, the motion of which is to be measured. It is also possible, however, that the target is provided directly by the component to be measured if the latter is electrically conductive. The electrically conductive measuring track or the electrically conductive correction track can be implemented, for example, as a raised area on this component.

The eddy current sensor can have a sensor circuit board, in which the detection coils of the measurement value sensor are implemented as planar coils. Other components can also be arranged on the PCB, such as the evaluation and control unit, which can induce an alternating current in the detection coils and/or measure a frequency of the alternating voltage in these detection coils.

The measurement value encoder and measurement value sensor are movable relative to each other. For example, the measurement value sensor is arranged on a shaft which can be rotated relative to the measurement value sensor. Alternatively, the measurement value sensor and the measurement value encoder can be attached to components which can be displaced relative to each other in the direction of the measurement path.

The correction coils and the correction tracks can be used to compensate for a tilting of the measurement value encoder relative to the measurement value sensor and/or a relative change in distance between these two components.

The measurement effect underlying a sensor assembly according to the invention for contactless displacement measurement is the change in the inductance of a detection coil when an electrically conductive material (target) is located over said coil. If an alternating voltage is applied to the detection coil, an electromagnetic alternating field is produced, which induces an eddy current in the target. This generates a field in the opposite direction to the first field, resulting in a reduced inductance of the sensor coil. If the coil is connected into an electrical oscillator circuit, this causes a change in the resonant frequency of the same. The more the sensor coil is covered by the target or the closer the target comes to the sensor coil, the greater is the frequency of the oscillator circuit. If, therefore, the distance between the sensor coil and target is held constant and the target is structured along the measurement path, this results in a change in frequency when the target passes over the detection coil.

Measuring the frequency, for example by counting or a lock-in method, therefore allows the target position to be inferred. Thus, embodiments of the sensor assembly are suitable for contactless displacement measurement as a linear position sensor. The capacitors used in the resonant circuit can be selected so that the resonance frequency is in the range of several tens of MHz.

In principle, one measuring coil and one measuring track on the target are sufficient in order to implement the linear position sensor. If a change in distance occurs, however, the resulting frequency change in the evaluation is automatically attributed to a displacement of the target. This leads to intolerable measurement errors. For this reason, additional correction tracks and correction coils are used, using which the target position relative to the sensor circuit board can be determined (distance, linear position, tilt). To this end, by means of a calibration process it is determined how the frequency behaves as a function of the distance between target and sensor circuit board in each target position. The calibration data can exist, for example, in the memory of am ASIC or a microcontroller, either as a look-up table or in analytical form.

The evaluation and control unit in the present case can be understood to mean an electrical device such as a control unit, which processes and/or evaluates detected sensor signals. The analysis and control unit can have at least one interface, which can be implemented in hardware and/or software. In the case of a hardware-based design, the interfaces can be, for example, part of a so-called system-ASIC, which includes the wide range of functions of the analysis and control unit. It is also possible, however, that the interfaces are dedicated integrated circuits, or at least in part consist of discrete components. In the case of a software-based design, the interfaces can be software modules which exist, for example, on a micro-controller in addition to other software modules. Also advantageous is a computer program product with program code, which is stored on a machine-readable medium, such as a semiconductor memory, a hard drive or an optical memory, and is used to perform the analysis when the program is executed by the analysis and control unit.

The measures and extensions listed in the dependent claims enable advantageous improvements of the sensor assembly for contactless displacement measurement specified in independent claim 1 and of the method specified in the independent claim 16 for determining a relative position of a sensor in relation to a target of a such a sensor assembly for contactless displacement measurement.

A particularly advantageous feature is that the eddy current sensor can comprise an assignment device with at least two measuring elements, wherein the evaluation and control unit evaluates control signals of the measuring elements and depending on the evaluation can determine which of the detection coils is positioned over a first region and which of the detection coils is positioned over a second region. The two measuring elements can be arranged behind one another along the measurement path in such a way that in the case of a positioning over the first regions of the at least one measuring track the measuring elements can be at least partially covered and in the case of a positioning over the second regions, are arranged outside of the at least one correction track. The two measuring elements can each output a control signal which can represent a degree of coverage of the corresponding measuring element by the at least one measuring track. In addition, the evaluation and control unit can digitize the control signals of the measuring elements by comparison with a threshold value. The evaluation and control unit can assign the corresponding control signal a logical first value “1” if the control signal reaches or exceeds the threshold value. The evaluation and control unit can assign the corresponding control signal a logical second value if the control signal is below the threshold value. In addition, in accordance with the logical combinations of the digitized control signals the evaluation and control unit can determine one of the detection coils, which is completely covered by one of the first regions, as the measuring coil and determine one of the detection coils, which is completely covered by one of the second regions, as the correction coil. A decision as to which detection coils are measuring coils and which are correction coils is therefore made on the basis of the two control signals which are output by the measuring elements of the assignment device. The decisive factor for the evaluation is which of these measuring elements is more covered by one of the measuring tracks of the target. For example, a suitable threshold can be defined as 50% coverage. Since the assignment uses only binary or digital information as to whether the coverage is greater than or less than the defined threshold value, the measuring elements can be designed to be much simpler than the detection coils. The assignment of the detection coils as measurement or correction coils can be carried out, for example, on the basis of a truth table of the two binary control signals.

In an advantageous design of the sensor arrangement, each of the measuring elements can be designed as a planar coil, wherein the at least one electrically conductive measurement track can influence the inductance of the planar coil of the respective measuring element due to eddy current effects, depending on the degree of coverage. The measurement and evaluation of the inductance change can then be carried out by interconnection into an electrical oscillator circuit. Alternatively, the measurement elements can each have two capacitor plates, wherein the at least one electrically conductive measurement track can influence a capacitive coupling between the two capacitor plates of the respective measuring element, depending on the degree of coverage. In the alternative embodiment, the capacitive coupling can be measured and evaluated.

In another advantageous design of the sensor arrangement, the common geometry can be applied on a printed circuit board of the target as a bounded surface, wherein the at least one electrically conductive measuring track has a variable width along the measurement path and the at least one electrically conductive correction track has a constant width along the measurement path.

In another advantageous design of the sensor arrangement, the measurement value sensor can comprise four detection coils, implemented as planar coils with rectangular or square cross section, which can run in at least one layer of a sensor printed circuit board. In addition, the detection coils can each be formed of two partial coils arranged adjacent to each other spaced apart with respect to the measurement path, which can be arranged mirror symmetrical with respect to the central longitudinal axis of the measurement value encoder.

In another advantageous design of the sensor assembly, the bounded surface can preferably form an equal-sided symmetrical trapezium. In this case a base of the trapezium can run perpendicular to the measurement path and correspond approximately to the length of a detection coil, and a height of the trapezium can correspond to at least a maximum measurement distance. The first regions and the second regions can each also form an equal-sided symmetrical trapezium, wherein a base of each trapezium can run perpendicular to the measurement path and the height of each trapezium can be at least equal to twice the width of a detection coil. In addition, the first regions can each be essentially covered by one measuring track, and the second regions can each comprise two correction tracks, which can be arranged mirror symmetrically with respect to the central longitudinal axis of the measurement value sensor.

In another advantageous design of the sensor arrangement, the eddy current sensor can be a linear position sensor and the target can be arranged along a linear measurement path. Alternatively, the eddy current sensor can be a rotation angle sensor and the target can be arranged on a shaft about a rotational axis.

In advantageous embodiment of the method, a distance travelled or a rotation angle can be calculated from the relative position of the eddy current sensor relative to the target.

Exemplary embodiments of the invention are shown in the drawing and are explained in more detail in the following description. In the drawing, the same reference numbers denote the same components or elements which perform identical or similar functions.

### BRIEF DESCRIPTION OF THE DRAWINGS

FIG. 1 shows a schematic block diagram of an exemplary embodiment of a sensor assembly according to the invention for contactless displacement measurement.

FIG. 2 shows a schematic plan view of the sensor assembly according to the invention for contactless distance measurement from FIG. 1 with a sensor printed circuit board shown transparent.

FIG. 3 shows a plan view of an exemplary embodiment of a partial coil of the sensor assembly according to the invention for contactless displacement measurement from FIGS. 1 and 2.

FIG. 4 shows a characteristic diagram which illustrates a dependency of a measurement signal on a distance between a target and a detection coil.

FIG. 5 shows a schematic representation of a detail of the sensor assembly according to the invention for contactless displacement measurement from FIGS. 1 and 2, with a first exemplary embodiment of an assignment device.

FIG. 6 shows a schematic representation of a detail of the sensor assembly according to the invention for contactless displacement measurement from FIGS. 1 and 2, with a second exemplary embodiment of the assignment device in a first coverage state.

FIG. 7 shows a schematic representation of a detail of the sensor assembly according to the invention for contactless displacement measurement from FIGS. 1 and 2, with a second exemplary embodiment of the assignment device in a second coverage state.

FIG. 8 shows a characteristic diagram with typical signal waveforms of a first control signal and a second control signal of the assignment device over a measurement path.

FIG. 9 shows a characteristic diagram with typical signal waveforms of degrees of coverage, which were calculated from measurement signals of the detection coils, and of control signals of the measuring elements of the assignment device over the measurement path.

FIG. 10 shows a characteristic diagram of a raw signal which is composed of the individual degrees of coverage, which were calculated from corresponding measurement signals detected over the measurement path by detection coils acting as measuring coils.

FIG. 11 shows a characteristic diagram of a position signal after correction of the known position offsets of the respective detection coils and assignment of raw signal and position.

### EMBODIMENTS OF THE INVENTION

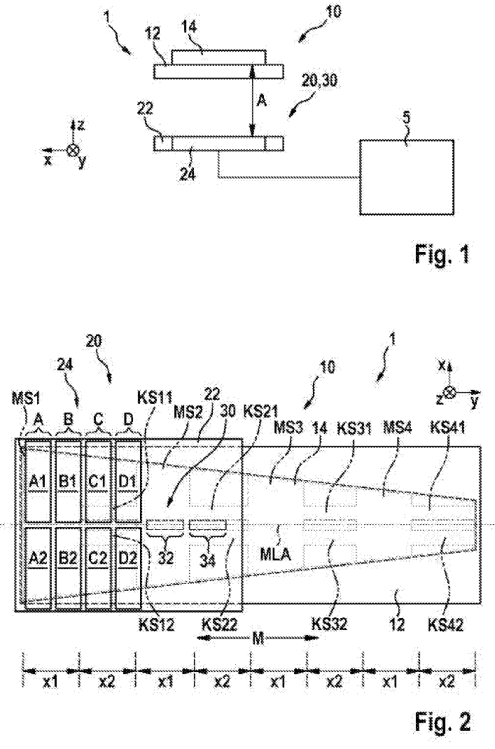

As is apparent from FIGS. 1 and 2, the exemplary embodiment shown of a sensor assembly according to the invention 1 for contactless displacement measurement comprises a target 10, which has a measurement value encoder 14 which extends along a measurement path M and has at least one electrically conductive measuring track MS1, MS2, MS3, MS4, and an eddy current sensor 20 with a measurement value sensor 22, which comprises at least two detection coils A, B, C, D. The measurement value sensor 22 is arranged at a distance A from the measurement value encoder 14 and is movable in a relative manner along the at least one electrically conductive measurement track MS1, MS2, MS3, MS4 and at least partly covers said measurement track. At least one of the detection coils A, B, C, D acts as a measuring coil, the measuring signal of which is evaluated by an evaluation and control unit 5 to determine the displacement. The measurement value encoder has at least one electrically conductive correction track KS11, KS12, KS21, KS22, KS31, KS32, KS41, KS42, which is arranged with the at least one electrically conductive measuring track MS1, MS2, MS3, MS4 within a common geometry, wherein first regions x1 with at least one electrically conductive measurement track MS1, MS2, MS3, MS4 and second regions x2 with at least one electrically conductive correction track KS11, KS12, KS21, KS22, KS31, KS32, KS41, KS42 alternate periodically along the measurement path M. At least one of the detection coils A, B, C, D acts as a correcting coil, the measuring signal of which is evaluated by the evaluation and control unit 5 to correct the determined displacement value. The action of the individual detection coils A, B, C, D as measurement coils or as correction coils varies along the measurement path M, wherein the evaluation and control unit 5 assigns a detection coil A, B, C, D the measurement coil action if the corresponding detection coil A, B, C, D is positioned over a first region x1, or the correction coil action if the corresponding detection coil A, B, C, D is positioned over a second region x2.

The underlying measuring effect of the sensor assembly 1 according to the invention for non-contact displacement measurement is the change in inductance of a detection coil A, B, C, D, if an electrically conductive material in the form of an electrically conductive measuring track MS1, MS2, MS3, MS4 or of an electrically conductive correction track KS11, KS12, KS21, KS22, KS31, KS32, KS41, KS42 is located above this coil. If an alternating voltage is applied to the detection coil A, B, C, D, an electromagnetic alternating field is produced, which induces an eddy current in the electrically conductive measuring track MS1, MS2, MS3, MS4 and/or electrically conductive correction track KS11, KS12, KS21, KS22, KS31, KS32, KS41, KS42. This generates a field in the opposite direction to the first field, resulting in a reduced inductance of the detection coil A, B, C, D. If the detection coil A, B, C, D is connected into an electrical oscillator circuit, this causes a change in the resonant frequency f₀ of the circuit according to equation (1).

$${f}_{c} = \frac{1}{2 π \sqrt{LC}} \qquad ( 1 )$$

The more the detection coil A, B, C, D is covered by the electrically conductive measuring track MS1, MS2, MS3, MS4 and/or the electrically conductive correction track KS11, KS12, KS21, KS22, KS31, KS32, KS41, KS42 or the closer the electrically conductive measuring track MS1, MS2, MS3, MS4 and/or the electrically conductive correction track KS11, KS12, KS21, KS22, KS31, KS32, KS41, KS42 comes to the detection coil A, B, C, D, the greater is the frequency of the oscillator circuit. If, therefore, the distance A between the target 10 and the eddy current sensor 20 is held constant and the target 10 is structured along the measurement path A, this results in a change in frequency when the detection coil A, B, C, D is passed over by the electrically conductive measuring track MS1, MS2, MS3, MS4 and/or the electrically conductive correction track KS11, KS12, KS21, KS22, KS31, KS32, KS41, KS42. Measuring the frequency, for example by counting or a lock-in method, therefore allows the target position to be inferred. This makes the sensor assembly 1 according to the invention suitable for contactless displacement measurement as a linear position sensor or as a rotation angle sensor. The capacitors used are chosen such that a frequency in the range of 10 to 100 MHz is obtained.

As is also apparent from FIG. 2, the common geometry is applied on a printed circuit board 12 of the target 10 as a bounded surface. The at least one measuring track MS1, MS2, MS3, MS4 has a variable width along the measurement path M and the at least one correction track KS11, KS12, KS21, KS22, KS31, KS32, KS41, KS42 has a constant width along the measurement path M. In the illustrated exemplary embodiment four first regions x1 periodically alternate with four second regions x2. The outer contour of the measured value encoder 14, shown by dashed lines, in the exemplary embodiment shown corresponds to a trapezium, the base of which is perpendicular to the measurement direction (y direction) or is oriented towards the measurement path M. The base has a length which corresponds approximately to the length of a detection coil A, B, C, D in the x-direction and can be within the range from a few millimeters to several centimeters. The height of the trapezium corresponds to at least a maximum measurement path M from a few centimeters up to several decimeters. The side of the trapezium opposite the base is designed correspondingly shorter than the base and should be designed to be not less than approximately 10% of the length of the detection coil A, B, C, D. Within the area bounded by the outer contour, recesses are formed periodically so that in the second regions x2 two correction tracks KS11, KS12, KS21, KS22, KS31, KS32, KS41, KS42 are formed, the widths of which are identical and do not change as a function of the y-position or along the measurement path M. In addition, the two correction tracks KS11, KS12, KS21, KS22, KS31, KS32, KS41, KS42 of the second regions x2 are arranged in each case mirror symmetrical with respect to the central longitudinal axis MLA of the measurement value encoder 14. The first regions x1 and the second regions x2 each also form an equal-sided symmetrical trapezium, the base of which extends perpendicular to the measurement path M. The height of the trapeziums or the length in the y-direction of the first and second regions x1, x2 is equal in each case to at least twice the width of a detection coil A, B, C, D in the y-direction. In addition, the first regions x1 are each substantially covered by an electrically conductive measuring track MS1, MS2, MS3, MS4, the width of which decreases in the measuring direction y.

By means of the illustrated arrangement of four detection coils A, B, C, D arranged adjacent to each other in the measuring direction y, each of the coils being implemented as a coil pair with two partial coils A1, A2, B1, B2, C1, C2, D1, D2, the first regions x1 can then be used for position determination, in other words the linear displacement measurement itself, and the second regions x2 for the compensation or correction of tolerances. Since the transition regions between the first regions x1 and the second regions x2 contain neither information about the measurement path nor about tolerances, in the above exemplary embodiment shown four detection coils A, B, C, D, or eight partial coils A1, A2, B1, B2, C1, C2, D1, D2, are used to ensure all measurement variables are always reliably determined.

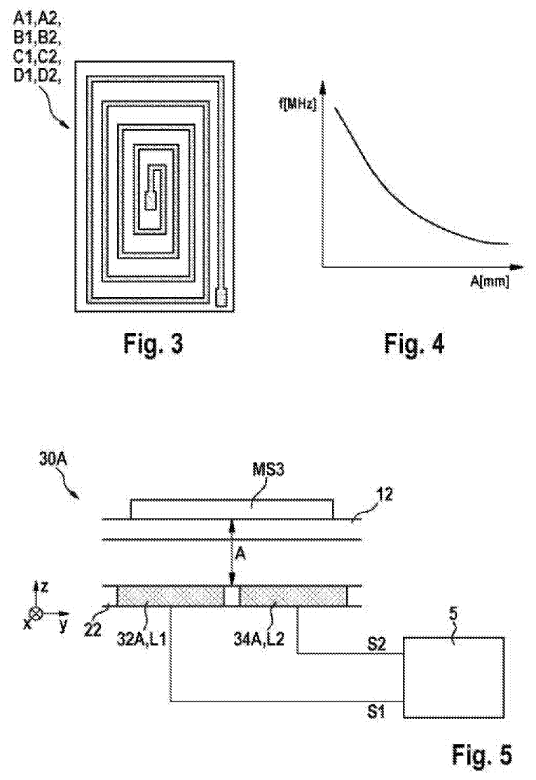

As is also apparent from FIG. 2, the four detection coils A, B, C, D are each formed of two partial coils A1, A2, B1, B2, C1, C2, D1, D2 arranged adjacent to each other spaced apart with respect to the measurement path M, which are arranged mirror symmetrical with respect to the central longitudinal axis MLA of the measurement value encoder 14. As is also apparent from FIG. 3, the partial coils A1, A2, B1, B2, C1, C2, D1, D2 of the four detection coils A, B, C, D of the measurement value sensor 22 are implemented in each case as planar coils with rectangular or square cross section, which extend in at least one layer of a sensor printed circuit board 22. The outer dimensions of the partial coils A1, A2, B1, B2, C1, C2, D1, D2 can be from a few millimeters to a few centimeters.

For each target position, the measuring signal and/or frequency signal of a detection coil A, B, C, D, or the measuring signals and/or frequency signals of the corresponding two partial coils A1, A2, B1, B2, C1, C2, D1, D2 which are located completely over a first region x1, are evaluated for measuring the target position. The measuring signal and/or frequency signal of a detection coil A, B, C, D, or the measuring signals and/or frequency signals of the corresponding two partial coils A1, A2, B1, B2, C1, C2, D1, D2 which are located completely over a second region x2, is or are used to provide the tolerance correction.

For the target position shown in FIG. 2, a first detection coil A is used for the displacement measurement and a third detection coil C for the tolerance compensation. If the target 10, or the measurement value encoder 14, is located at a setpoint distance A of approx. 0.5 mm and if the target 10 or measurement value encoder 14 is not tilted about the axis (y-axis) along the measurement path M, both frequency signals of the partial coils C1, C2 of the third detection coil C have nearly identical setpoint values fsetpoint, so that no correction of the frequency signals output by the two partial coils A1, A2 of the first detection coil A is performed. If both frequencies are greater than the setpoint value fsetpoint and almost identical, then the target 10 is closer to the sensor printed circuit board than the setpoint distance A and the measurement frequencies of the partial coils A1, A2 of the first detection coil A must be corrected downwards. A tilting about the y-axis causes the measurement frequencies of the partial coils C1, C2 of the third detection coil C to differ. Due to the non-linear relationship between the measurement frequency and the distance A in accordance with the characteristic curve in FIG. 4, a correction is required here also. A decision as to which detection coil A, B, C, D acts as a measuring coil and which acts as a correction coil is made on the basis of two control signals S1, S2 which are detected by measuring elements 32, 34 of an assignment device 30.

As is further apparent from FIG. 2, the two measuring elements 32, 34 are arranged behind one another along the measurement path M in such a way that in the case of a positioning over the first regions x1 of the at least one measuring track MS1, MS2, MS3, MS4 the measuring elements 32, 34 are at least partially covered and in the case of a positioning over the second regions x1, are arranged outside of the at least one correction track KS11, KS12, KS21, KS22, KS31, KS32, KS41, KS42. The two measuring elements 32, 34 each output a control signal S1, S2, which represents a degree of coverage of the corresponding measuring element 32, 34 by the at least one measuring track MS1, MS2, MS3, MS4. The two measuring elements 32, 34 of the assignment device 30 are arranged on the sensor printed circuit board 22 of the eddy current sensor 20. The evaluation and control unit 5 evaluates the control signals S1, S2 of the measuring elements 32, 34, and depending on the evaluation determines which of the detection coils A, B, C, D is positioned over a first region x1, and which of the detection coils is positioned over a second region x2. The decisive factor for the evaluation is which of these measuring elements 32, 34 is more covered by the electrically conductive measuring track MS1, MS2, MS3, MS4. For example, a suitable threshold S can be defined as 50% coverage. Since binary information is used to determine whether the coverage is greater than or less than the defined threshold value S, the measuring elements 32, 34 can be designed much simpler than the detection coils A, B, C, D.

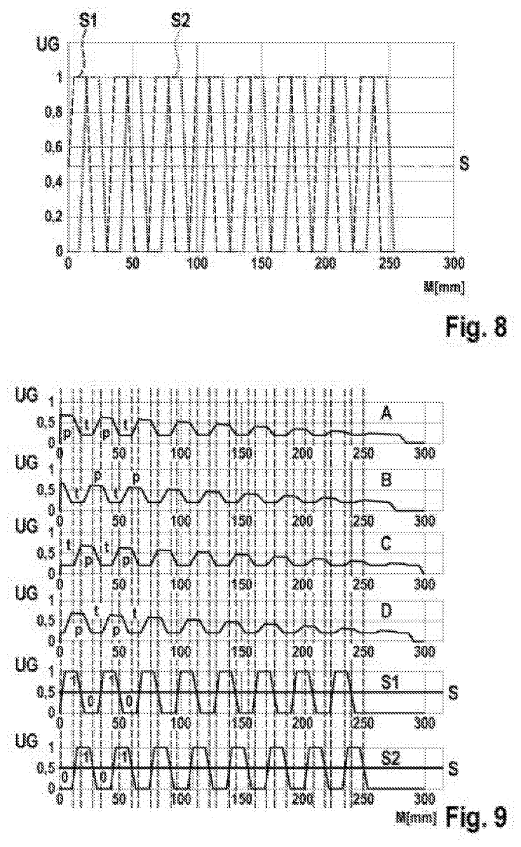

The evaluation and control unit 5 digitizes the control signals S1, S2 of the measuring elements 32, 34 by comparison with the threshold value S, which in the exemplary embodiment shown corresponds to 50% coverage level UG. FIGS. 8 and 9 each show the waveform of the two control signals S1, S2. The evaluation and control unit 5 assigns the corresponding control signal S1, S2 a logical first value “1” if the control signal S1, S2, or the coverage level UG, reaches or exceeds the threshold value S. The evaluation and control unit 5 assigns the corresponding control signal S1, S2 a logical second value “0” if the control signal S1, S2 or the coverage level UG is below the threshold value S. In accordance with the logical combinations of the digitized control signals S1, S2, which are shown in a truth table 1, the evaluation and control unit 5 determines one of the detection coils A, B, C, D, which is completely covered by one of the first regions x1, as the measuring coil, and one of the detection coils A, B, C, D, which is completely covered by one of the second regions x2, as the correction coil. The assignment of the detection coils A, B, C, D as measurement or correction coils is performed on the basis of the truth table 1, where S indicates the threshold value of the coverage level of the measurement elements 32, 34 by one of the electrically conductive measuring tracks MS1, MS2, MS3, MS4.

TRUTH TABLE 1

| S1 | S2 | Measurement coil | Correction coil |
|---|---|---|---|
| <S | <S | D | B |
| <S | >S | C | A |
| >S | >S | B | D |
| >S | <S | A | C |

As is further apparent from FIG. 2, in the relative position shown between the target 10 and the eddy current sensor 20, which in the exemplary embodiment shown corresponds to an initial position, the first detection coil A is completely covered by a first region x1 arranged a left-hand edge of the common geometry, and a second detection coil B is located in the transition region between the first region x1 arranged at the edge and a subsequent second region x2 and is partially covered by the first region x1 and partially covered by the second region x2. In addition, the third detection coil C is completely covered by the second region x2 and a fourth detection coil D is located in the transition region between the second region x1 and a subsequent first region x1 and is partially covered by the second region x2 and partially covered by the first region x1. The first measuring element 32 is arranged in a subsequent first region x1 and is completely covered by this first region x1, so that the binary first control signal S1 has the logical first value “1”. The second measuring element 43 is arranged in a subsequent second region x2 and is completely covered by this second region x2, so that the binary second control signal S2 has the logical second value “0”.

As is also apparent from FIG. 5, the measuring elements 32A, 34A in the illustrated first exemplary embodiment of the assignment device 30A are each implemented as a planar coil L1, L2 which are arranged in at least one layer of the sensor printed circuit board 22. The at least one electrically conductive measuring track MS1, MS2, MS3, MS4 affects the inductance of the planar coil L1, L2 of the respective measuring element 32A, 34A due to eddy current effects, depending on the degree of coverage UG.

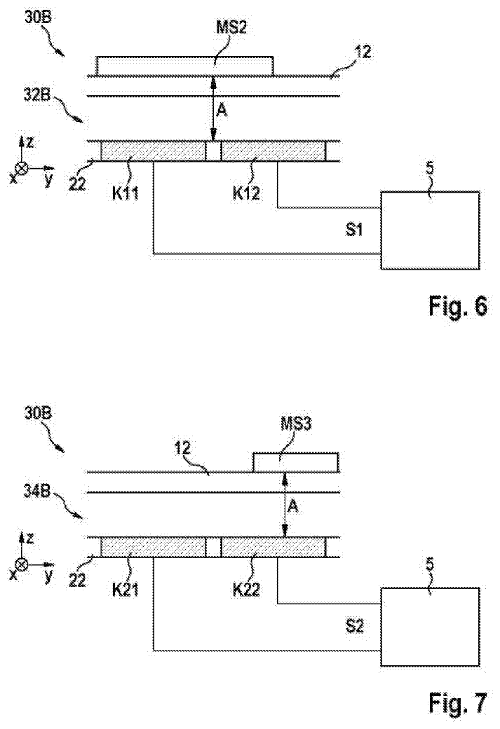

As is further apparent from FIGS. 6 and 7, the measuring elements 32B, 34B in the second exemplary embodiment shown of the assignment device 30B each have two capacitor plates K11, K12, K21, K22, which are embedded in the sensor printed circuit board 22 adjacent to each other in the measuring direction (y-direction). The at least one measuring track MS1, MS2, MS3, MS4 affects a capacitive coupling between the two capacitor plates K11, K12, K21, K22 of the respective measuring element 32B, 34B depending on the degree of coverage. As is further apparent from FIG. 6, due to the electrically conductive measuring track MS2, which completely covers a first capacitor plate K11 and partially covers a second capacitor plate K12 of the first measuring element 32B, a capacitive coupling occurs between the first and second capacitor plate K11, K12. As is further apparent from FIG. 7, the electrically conductive measuring track MS3 does not cover a first capacitor plate K21 at all and only partially covers a second capacitor plate K22 of the measuring element 34B, so that no capacitive coupling is present between the first and second capacitor plate K11, K22. The measured capacitive coupling is a measure of the coverage of the first measuring element 32B or of the second measuring element 34B.

FIG. 9 shows typical signal waveforms of coverage levels UG, which were calculated from the measurement signals of the detection coils A, B, C, D, and of control signals S1, S2 of the measuring elements 32, 34 of the assignment device 30 over the measurement path M, as well as the assignment of the detection coils A, B, C, D to the measuring function p or to the correction function t by the binary digitized control signals in accordance with truth table 1.

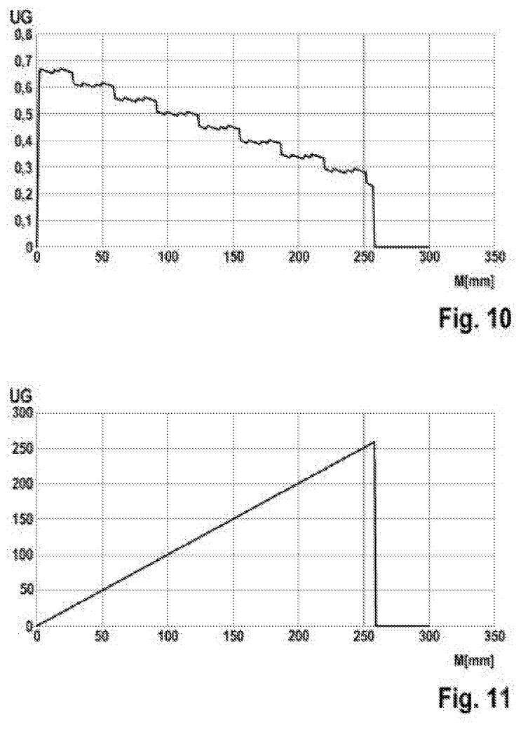

FIG. 10 shows a characteristic diagram of a raw signal which is composed of the individual degrees of coverage UG, which were calculated from corresponding measurement signals detected over the measurement path M by detection coils A, B, C, D acting as measuring coils. FIG. 11 shows a position signal after correction of the known position offsets of the respective detection coils A, B, C, D and assignment of raw signal and position.

The method for determining a relative position of an eddy-current sensor 20 in relation to a target 10 of a sensor assembly 1 described above for contactless displacement measurement assigns a detection coil A, B, C, D the measurement coil action if the corresponding detection coil A, B, C, D is positioned over a first region x1, or the correction coil action if the corresponding detection coil A, B, C, D is positioned over a second region x2. At least one measuring signal of the detection coil A, B, C, D acting as a correction coil is measured and evaluated to determine a spatial position of the measurement value sensor 24 relative to the measurement value encoder 14. At least one measuring signal of the detection coil A, B, C, D acting as a measuring coil is measured and corrected based on the determined spatial location of the measurement value sensor 24 relative to the measurement value encoder 14, wherein the relative position of the eddy current sensor 20 in relation to the target (10) is determined from the corrected measuring signal of the detection coil A, B, C, D acting as a measuring coil.

From the relative position of the eddy current sensor 20 relative to the target 10, a distance travelled, or a rotation angle can then be calculated.

This method can be implemented, for example, in software or hardware or in a combination of software and hardware, for example in an analysis and control unit 5 or in a control unit.

1. A sensor assembly for detecting a displacement in a contactless manner, comprising:
a target including a measurement value encoder, the measurement value encoder configured to move along a measurement path and having
at least one electrically conductive measurement track, and
at least one electrically conductive correction track arranged together with the at least one electrically conductive measurement track within a common geometry; and
an eddy current sensor including a measurement value sensor, the measurement value sensor having at least two detection coils arranged at a distance from the measurement value encoder, and movable in a relative manner along the at least one electrically conductive measurement track, and at least partly covering the at least one electrically conductive measurement track,
wherein at least one detection coil of the at least two detection coils is configured as a measurement coil,
wherein a measurement signal of the measurement coil is evaluated by an evaluation and control unit in order to detect a displacement,
wherein first regions including at least one electrically conductive measurement track and second regions with including at least one electrically conductive correction track alternate periodically along the measurement path,
wherein at least one detection coil of the at least two detection coils is configured as a correction coil,
wherein a measurement signal of the correction coil is evaluated by the evaluation and control unit in order to correct the displacement detection,
wherein action of each of the at least two detection coils as measurement coils or as correction coils varies along the measurement path, and
wherein the evaluation and control unit assigns a detection coil of the at least two detection coils the measurement coil action if the corresponding detection coil is positioned over a first region or the correction coil action if the corresponding detection coil is positioned over a second region.

2. The sensor assembly as claimed in claim 1, wherein:
the eddy current sensor includes an assignment device having at least two measuring elements; and
the evaluation and control unit evaluates control signals of the at least two measuring elements, and, depending on the evaluation, determines which of the at least two detection coils is positioned over a first region, and which of the at least two detection coils is positioned over a second region.

3. The sensor assembly as claimed in claim 2, wherein:
the at least two measuring elements are arranged behind one another along the measurement path such that (i) in a case of a positioning over the first regions of the at least one electrically conductive measuring track, the at least two measuring elements are at least partially covered, and (ii) in a case of a positioning over the second regions, the at least two measuring elements are arranged outside of the at least one electrically conductive correction track; and
the at least two measuring elements each output a control signal which represents a degree of coverage of the corresponding measuring element of the at least two measuring elements by the at least one electrically conductive measuring track.

4. The sensor assembly as claimed in claim 3, wherein:
the evaluation and control unit digitizes the control signals of the at least two measuring elements by comparison with a threshold value;
the evaluation and control unit assigns the corresponding control signal a logical first value when the control signal reaches or exceeds the threshold value; and
the evaluation and control unit assigns the corresponding control signal a logical second value if the control signal is below the threshold value.

5. The sensor assembly as claimed in claim 4, wherein, in accordance with logical combinations of the digitized control signals, the evaluation and control unit is configured to determine one detection coil of the at least two detection coils, which is completely covered by one first region of the first regions, as the measuring coil, and one detection coil of the at least two detection coils, which is completely covered by one second region of the second regions, as the correction coil.

6. The sensor assembly as claimed in claim 2, wherein:
the at least two measuring elements are each configured as a planar coil; and
the at least one electrically conductive measuring track affects inductance of the planar coil of the respective measuring element of the at least two measuring elements due to eddy current effects depending on the degree of coverage.

7. The sensor assembly as claimed in claim 2, wherein:
the at least two measuring elements each have two capacitor plates; and
the at least one electrically conductive measuring track affects a capacitive coupling between the two capacitor plates of the respective measuring element of the at least two measuring elements depending on the degree of coverage.

8. The sensor assembly as claimed in claim 1, wherein:
the common geometry is applied on a printed circuit board of the target as a bounded surface; and
the at least one electrically conductive measuring track includes a variable width along the measurement path and the at least one electrically conductive correction track includes a constant width along the measurement path.

9. The sensor assembly as claimed in claim 8, wherein the at least two detection coils include four detection coils configured as planar coils with rectangular or square cross section, which extend in at least one layer of a sensor circuit board.

10. The sensor assembly as claimed in claim 8, wherein:
the at least two detection coils are each formed of two partial coils arranged adjacent to each other spaced apart with respect to the measurement path, and which are arranged mirror symmetrical with respect to a central longitudinal axis of the measurement value encoder.

11. The sensor assembly as claimed in claim 8, wherein:
the bounded surface is a first equal-sided symmetrical trapezium;
a base of the first equal-sided symmetrical trapezium runs perpendicular to the measurement path and is approximately equal in length to a detection coil of the at least two detection coils; and
a height of the first equal-sided symmetrical trapezium corresponds to at least one maximum measurement path.

12. The sensor assembly as claimed in claim 11, wherein:
the first regions and the second regions are each a second equal-sided symmetrical trapezium; wherein
each base of the second equal-sided symmetrical trapeziums runs perpendicular to the measurement path; and
a height of each second equal-sided symmetrical trapezium is at least equal to twice the width of a detection of the at least two detection coils.

13. The sensor assembly as claimed in claim 12, wherein:
the first regions are each substantially covered by an electrically conductive measuring track, and the second regions each include two electrically conductive correction tracks which are arranged mirror symmetrically to a central longitudinal axis of the measurement value encoder.

14. The sensor assembly as claimed in claim 1, wherein the eddy current sensor is a linear displacement sensor and the target is arranged along a linear measurement path.

15. The sensor assembly as claimed in claim 1, wherein the eddy current sensor is a rotation angle sensor and the target is arranged on a shaft about a rotational axis.

16. A method for determining a relative position of an eddy-current sensor of a sensor assembly in relation to a target of the sensor assembly for contactless displacement measurement, the target including a measurement value encoder configured to move along a measurement path and having at least one electrically conductive measurement track and at least one electrically conductive correction track arranged together with the at least one electrically conductive measurement track within a common geometry, the eddy current sensor including a measurement value sensor having at least two detection coils, the measurement value sensor arranged at a distance from the measurement value encoder, movable in a relative manner along the at least one electrically conductive measurement track, and at least partly covering the at least one electrically conductive measurement track, the method comprising:
assigning a detection coil of the at least two detection coils action of a measuring coil if the corresponding detection coil is positioned over a first region or is assigning a detection coil of the at least two detection coils action of a correction coil if the corresponding detection coil is positioned over a second region;
measuring and evaluating via an evaluation and control unit at least one measuring signal of a detection coil of the at least two detection coils configured to act as a correction coil to determine a spatial position of the measurement value sensor relative to the measurement value encoder;
measuring and correcting via the evaluation and control unit at least one measuring signal from a detection coil of the at least two detection coils configured to act as a measuring coil based on the spatial position of the measurement value sensor relative to the measurement value encoder; and the
determining a relative position of the eddy current sensor in relation to the target from the measured and corrected at least one measuring signal of the detection coil acting as a measuring coil,
wherein the first regions include at least one electrically conductive measurement track and the second regions include at least one electrically conductive correction track,
wherein the first regions and the second regions alternate periodically along the measurement path, and
wherein action of each of the at least two detection coils as measurement coils or as correction coils varies along the measurement path.

17. The method as claimed in claim 16, further comprising:
calculating a distance travelled or a rotation angle from the relative position of the eddy current sensor relative to the target.
